(19) United States
(12) Patent Application Publication
(10) Pub. No.: US 2007/0198630 A1
(43) Pub. Date: Aug. 23, 2007

(54) Delivery of archived content to authorized users

(76) Inventors: Lee Jacobson, Rochester, MN (US); James Young McVea JR., Chapel Hill, NC (US); Lee R. Perlov, Cary, NC (US)

Correspondence Address: DILLON & YUDELL LLP, 8911 N. CAPITAL OF TEXAS HWY., SUITE 2110, AUSTIN, TX, 78759, US

(21) Appl. No.: 11/327,551

(22) Filed: Jan. 6, 2006

(51) Int. Cl. G06F 15/16

(52) U.S. Cl. 709/203

(57) ABSTRACT

A method and system for consolidating old support documents for a product that is out-of-support into a single archive file package (“archive package”) that is accessible from a single webpage. The archive package includes static and unchanging updates, fixes, redbooks, Authorized Problem Analysis Reports (APARs) and Document Control Facility (DCF) published content related to the out-of-support product. To access and use the archive package, the provider of the product and/or its support then provides access to the archive package to users, either by storing the archive package on a server, or by downloading the archive package to the user's computer as a single document. Because the product is out-of-support, no new documents/downloads/plug-ins etc. will be developed by the producer in the future, and thus the archive package will contain the latest content related to the out-of-support product.

### BACKGROUND OF THE INVENTION

The present invention relates in general to the field of computers and similar technologies, and in particular to software utilized in this field.

Support-related content available on the Internet is typically applicable to a particular product and version. This support-related content includes links to help websites, technotes in repositories such as the Document Center Facility (DCF) used by IBM, fixes, PDF files and other non-crawlable (i.e., cannot be located by a Web crawler or similar logic) content, etc. When the product/version is removed from official support status, Web-based out-of-support content is either left on the Web or it is removed from the Web.

If the support-related content is left on the Web, there are a number of negative side effects. First, users of supported product releases find the out-of-support content during searches, and then mistake the out-of-support content as being relevant to the supported product releases. When these users attempt to use the out-of-date information, service calls are often generated from confused and irritated users. Second, content authors and administrators must respond to users who submit Document Level Feedback (DLF) when standards for published documents change, thereby increasing their workload. Third, authors and administrators receive notices when content begins to expire. When content is not set to expire, the amount of content available on the Web continues to increase, further complicating searches by users.

Simply removing the content from the Web poses its own problems. One of the most serious problems with simply removing out-of-support content from the Web includes annoying legacy customers who might have paid for this support content, even though it has been removed from official support status, through an extended support agreement.

### SUMMARY OF THE INVENTION

To address the need described above for an improved method and system for managing out-of-support content on the Web, the present invention includes, but is not limited to, a method, apparatus and computer-usable medium for consolidating documents for a product that is out-of-support into a single archive file package (“archive package”) that is accessible from a single webpage. The archive package includes static and unchanging updates, fixes, redbooks, Authorized Problem Analysis Reports (APARs) and Document Control Facility (DCF) published content related to the out-of-support product. To access and use the archive package, the provider of the product and/or its support then provides access to users, either by storing the archive package on a server, or by downloading to the user's computer the archive package (which may be delivered as a Zip file). Because the product is out-of-support, no new documents/downloads/plug-ins etc. will be developed for that product by the producer in the future. Thus, the archive package can be considered a static, unchanging artifact. By being directly accessed by the user at the user's computer, the user can be assured of having the latest product support for the out-of-support product. To let users of the out-of-support product know that they can access the archive package, a flash message is published, on a webpage for a newer in-support version of the now out-or-support product, announcing the availability of the archive package for the out-of-support product. Note that content in the archive package includes both content locatable by a web crawler as well as content that is not locatable by a web crawler.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates a webpage having a link to a single-source collection of content for an out-of-support product;

FIG. 2 depicts differently formatted content, both crawlable as well as non-crawlable, that can be included in the single-source collection of content for the out-of-support product;

FIG. 3 illustrates a flow-chart of exemplary steps taken to create and deploy the single-source collection of content for the out-of-support product;

FIG. 4 depicts an exemplary client computer in which the present invention could be implemented;

FIG. 5 illustrates an exemplary server from which software for executing the present invention may be deployed and/or implemented for the benefit of a user of the client computer shown in FIG. 4;

FIGS. 6a-b show a flow-chart of steps taken to deploy software capable of executing the steps shown and described in FIGS. 1-3;

FIGS. 7a-c show a flow-chart of steps taken to deploy in a Virtual Private Network (VPN) software that is capable of executing the steps shown and described in FIGS. 1-3;

FIGS. 8a-b show a flow-chart showing steps taken to integrate into a computer system software that is capable of executing the steps shown and described in FIGS. 1-3; and

FIGS. 9a-b show a flow-chart showing steps taken to execute the steps shown and described in FIGS. 1-3 using an on-demand service provider.

### DETAILED DESCRIPTION OF THE PREFERRED EMBODIMENT

A method, apparatus and computer-usable medium is presented for providing a way to manage out-of-support Web content. Documentation and solutions related to an out-of-support release of a software program/package/resource are collected for packaging in order to separate the out-of-support release-related content from content for other (e.g., more current) releases. The content includes updates and fixes on a File Transfer Protocol (FTP) server, an information center (i.e., a centralized help webpage), redbooks (publications and/or guides related to a particular content), Authorized Problem Analysis Reports (APARs) related to one or more releases, and Document Control Facility (DCF)-published content (such as technotes). By bundling such content into a single package, a user is able to easily access all content related to an out-of-support product. Since the product is no longer being dynamically supported, the content is static, and thus does not need to be maintained (e.g., updated, monitored, etc.).

In order to extract APARs, DCF-published and other content, an enhanced extractor tool saves the bundled collection of content as a documentation plug-in for (preferably Eclipse-based) information centers (webpages). By capturing all content, including the DCF-published content, into a single downloadable document, links to the content can point to local copies of content such as updates and fixes, rather than to links where such content was originally stored/published. This allows users to access the updates and fixes directly from the local copy of the DCF download, either by accessing ZIP files containing the DCF download on an FTP server, or by downloading the DCF download directly onto the user's workstation.

Once the combined content is available, a DCF flash (alert) on the content-provider's website can alert users of the availability of the (now-archived) content for the out-of-support product.

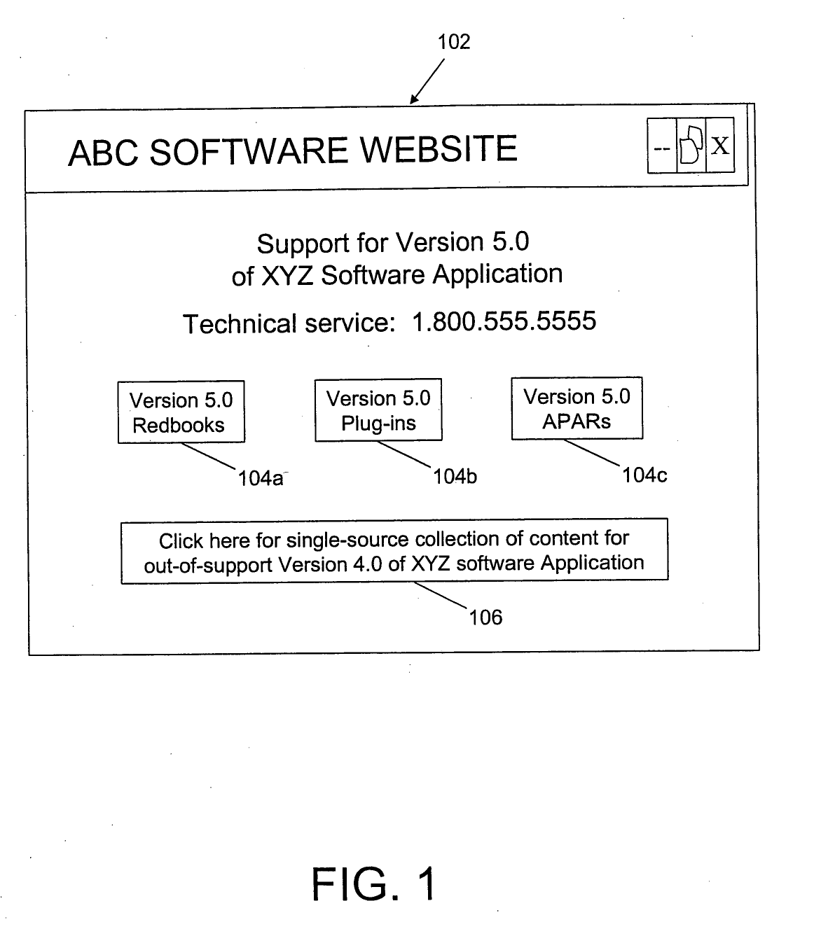

Referring now to FIG. 1, an exemplary webpage 102 is presented showing a user's view of what is provided using the present invention as described below. Webpage 102 is supported/mastered by a product provider, such as “ABC Software.” On webpage 102 is support information related to a current Version 5.0 of “XYZ Software Application.” This support information includes a telephone number for support for this version of the software, as well as hot links 104a-c for redbooks, plug-ins, and Authorized Problem Analysis Reports (APARs) for Version 5.0. Note that support information for Version 5.0 is dynamic, meaning that it is continually being updated due to the continual-improvement nature of such support. However, support for the out-of-support product is static, since support resources are spent on current, rather than out-of-date, versions of the product. However, if the user is authorized to continue to use the out-of-date version of the product, and is authorized to receive on-line support for the out-of-date version, then he is invited to click link button 106, which will provide the user access to a consolidated file containing all old support related to Version 4.0.

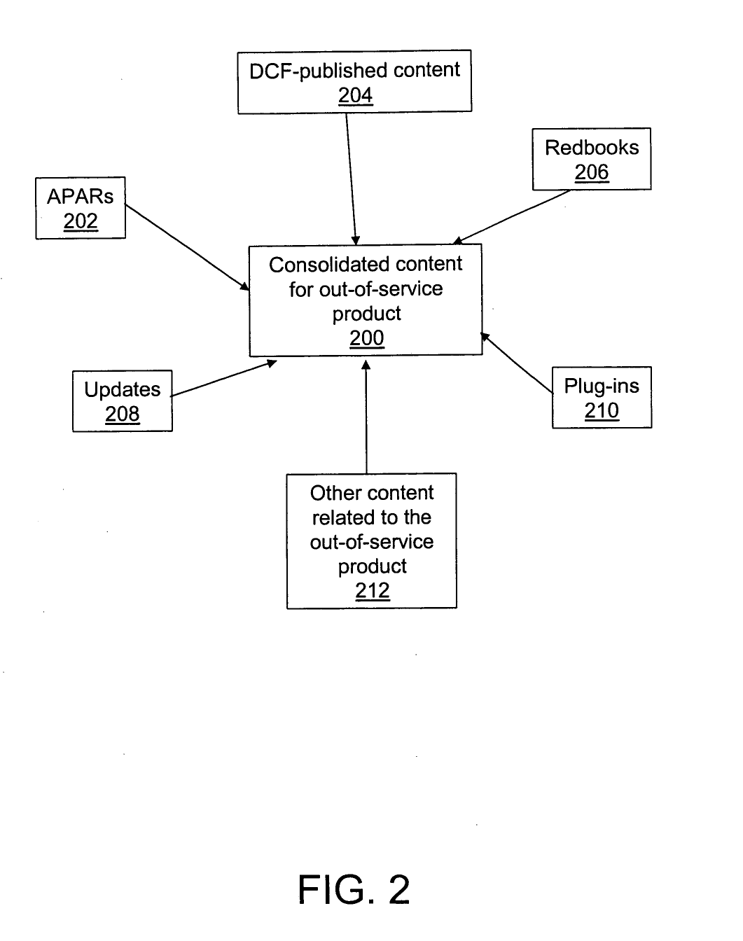

As shown in FIG. 2, this support content is consolidated into a consolidated content 200 from multiple sources, including APARs 202 for older Version 4.0, Document Control Facility (DCF) published content 204, redbooks 206, updates 208, plug-ins 210, and other content 212 related to Version 4.0. Preferably, all such content except content 212 is maintained by the creator of the product (e.g., XYZ Software Application). Content 212 may or may not be the creation of the creator of the product, but is nonetheless crawlable under the present invention. Note that DCF is a representative publishing tool that allows authors to create and publish documents according to specified topics.

Returning to FIG. 1, when the user clicks link button 106, a link to a single download document (consolidated content 200) is found, as well as the one Flash that points to this download. Besides inherent content (articles, etc.) found in the download, the download includes links to files on an FTP server that lets the user locally install a zipped consolidation file that contains archived information center for Version 4.0, APARs and DCF published content, individual redbooks, and fix packs and interim fixes referenced by download documents. The user can now search the redbooks, APARs, DCF downloads, DCF technotes and other information locally (on his own workstation or on-line with the FTP server), with links to referenced files located in the same directory in an unzipped version of the zipped consolidation file.

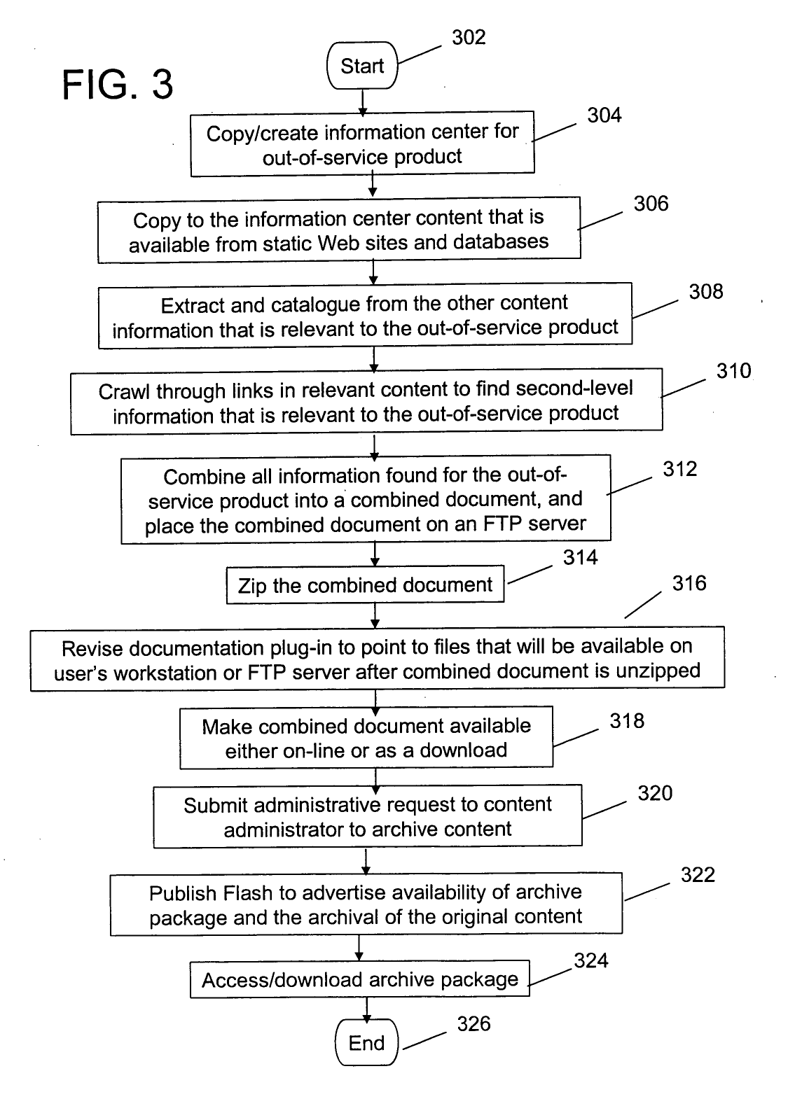

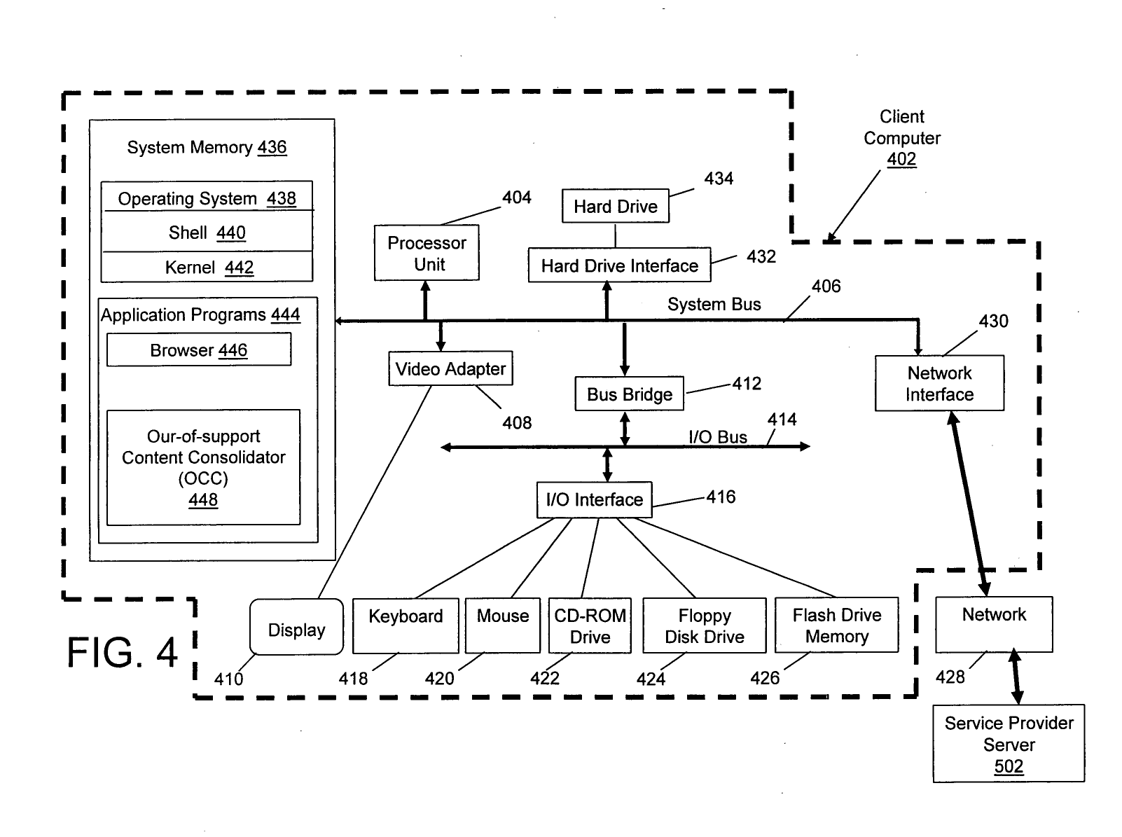

With reference now to FIG. 3, a flow-chart of exemplary steps taken by the present invention is presented. After initiator block 302, an information center for out-of-support product is established (block 304), either by copying an existing information center or by creating a new information center. Note that the information center uses an embedded web application server (such as an FTP server) to handle content requests in the system. This embedded web server uses a random port to avoid port conflicts between applications. Thus, plug-ins can be integrated into the information center for viewing by users. The information center (which is preferably Eclipse-based), provides a run-time framework in which documentation such as plug-ins, links, redbooks, etc. can be attached, thus affording a simple method to deliver such documentation to the user of the out-of-support product.

As described at block 306, content that is found at static Web sites and other databases is then copied into the information center. For example, if a static Web site, which was originally designated to support the out-of-support product, has a PDF file link, this link is found and copied by crawling that static Web site. This data, as well as other located relevant data/content, is then plugged into the Eclipse framework that is the information center, as described in block 308. This content is also catalogued, in order to afford ease of retrieval by the user.

As described in block 310, secondary content is located by crawling through links of found Web pages. For example, if a located Web page has a link to another page or a PDF file, including plug-in files and updates located on an FTP server, the web crawling browser will go to that Web page and save the Uniform Resource Locator (URL) pointer to either a Web page or to the FTP server.

All located relevant content is then placed onto the FTP server (block 312), and is segregated out according to the cataloguing of information performed in step 308. The combined relevant content is assimilated into a single consolidated content file, such as consolidated content 214 described above in FIG. 2. For ease of future downloading and to save storage space, this consolidated content is delivered as a Zip file (block 314). Note that, alternatively, the consolidated content (archive package) may be zipped at a later date, just before being made available for downloading as described below in block 318.

The zipped consolidated content can either be accessed from the FTP server, or it can be downloaded (once) to the user's workstation. Either way, note that once consolidated, the content is static, and thus the consolidated content is not to be revised. When downloading the consolidated content, however, a documentation plug-in is needed to point to files in the consolidated content after the consolidated content is unzipped. Thus, the documentation plug-in associated with the unzipped consolidated content needs to be revised to conform with the zipped version (block 316).

To make the consolidated content easily accessible in a single location (such as shown in FIG. 1), the support page for the product includes a single document, preferably using a Document Control Facility (DCF), which publishes a webpage describing the availability of the consolidated content, either on-line or as a single download (block 318). The content administrator who manages the support for the different versions of the product is notified of the existence and location of the newly created consolidated content (block 320). Finally, users are made aware of the consolidated content's existence through the use of Flash notices in the product producer's webpage (block 322). If he has not already done so, the user may on-line access the archive package, or may download the archive package in either unzipped or zipped format (block 324), and the process ends (terminator block 326).

With reference now to FIG. 4, there is depicted a block diagram of an exemplary client computer 402, in which the present invention may be utilized. Client computer 402 includes a processor unit 404 that is coupled to a system bus 406. A video adapter 408, which drives/supports a display 410, is also coupled to system bus 406. System bus 406 is coupled via a bus bridge 412 to an Input/Output (I/O) bus 414. An I/O interface 416 is coupled to I/O bus 414. I/O interface 416 affords communication with various I/O devices, including a keyboard 418, a mouse 420, a Compact Disk-Read Only Memory (CD-ROM) drive 422, a floppy disk drive 424, and a flash drive memory 426. The format of the ports connected to I/O interface 416 may be any known to those skilled in the art of computer architecture, including but not limited to Universal Serial Bus (USB) ports.

Client computer 402 is able to communicate with a service provider server 502 via a network 428 using a network interface 430, which is coupled to system bus 406. Network 428 may be an external network such as the Internet, or an internal network such as an Ethernet or a Virtual Private Network (VPN). Using network 428, client computer 402 is able to use the present invention to access service provider server 502.

A hard drive interface 432 is also coupled to system bus 406. Hard drive interface 432 interfaces with a hard drive 434. In a preferred embodiment, hard drive 434 populates a system memory 436, which is also coupled to system bus 406. Data that populates system memory 436 includes client computer 402's operating system (OS) 438 and application programs 444.

OS 438 includes a shell 440, for providing transparent user access to resources such as application programs 444. Generally, shell 440 is a program that provides an interpreter and an interface between the user and the operating system. More specifically, shell 440 executes commands that are entered into a command line user interface or from a file. Thus, shell 440 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 442) for processing. Note that while shell 440 is a text-based, line-oriented user interface, the present invention will equally well support other user interface modes, such as graphical, voice, gestural, etc.

As depicted, OS 438 also includes kernel 442, which includes lower levels of functionality for OS 438, including providing essential services required by other parts of OS 438 and application programs 444, including memory management, process and task management, disk management, and mouse and keyboard management.

Application programs 444 include a browser 446. Browser 446 includes program modules and instructions enabling a World Wide Web (WWW) client (i.e., client computer 402) to send and receive network messages to the Internet using HyperText Transfer Protocol (HTTP) messaging, thus enabling communication with service provider server 502.

Application programs 444 in client computer 402's system memory also include an Out-of-support Content Consolidator (OCC) 448. OCC 448 includes code for implementing the processes described in FIGS. 1-3. In one embodiment, client computer 402 is able to download OCC 448 from service provider server 502.

The hardware elements depicted in client computer 402 are not intended to be exhaustive, but rather are representative to highlight essential components required by the present invention. For instance, client computer 402 may include alternate memory storage devices such as magnetic cassettes, Digital Versatile Disks (DVDs), Bernoulli cartridges, and the like. These and other variations are intended to be within the spirit and scope of the present invention.

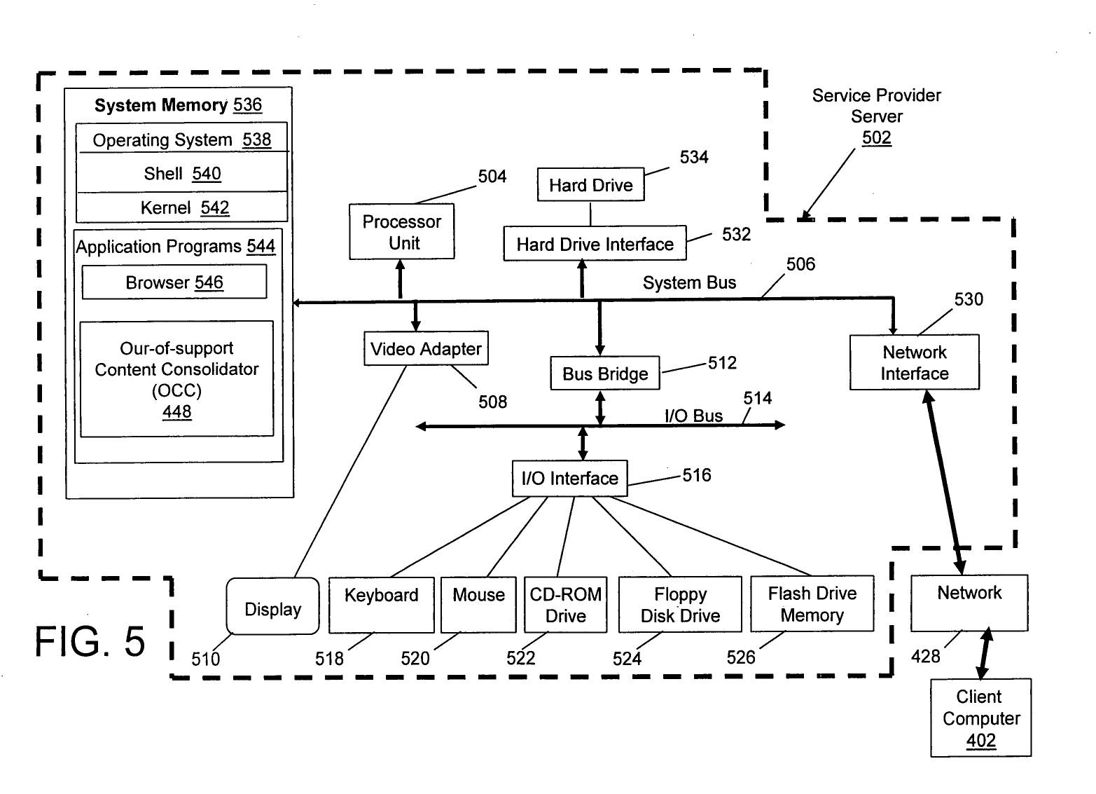

As noted above, OCC 448 can be downloaded to client computer 502 from service provider server 502, shown in exemplary form in FIG. 5. Service provider server 502 includes a processor unit 504 that is coupled to a system bus 506. A video adapter 508 is also coupled to system bus 506. Video adapter 508 drives/supports a display 510. System bus 506 is coupled via a bus bridge 512 to an Input/Output (I/O) bus 514. An I/O interface 516 is coupled to I/O bus 514. I/O interface 516 affords communication with various I/O devices, including a keyboard 518, a mouse 520, a Compact Disk-Read Only Memory (CD-ROM) drive 522, a floppy disk drive 524, and a flash drive memory 526. The format of the ports connected to I/O interface 516 may be any known to those skilled in the art of computer architecture, including but not limited to Universal Serial Bus (USB) ports.

Service provider server 502 is able to communicate with client computer 402 via network 428 using a network interface 530, which is coupled to system bus 506. Access to network 428 allows service provider server 502 to execute and/or download OCC 448 to client computer 402.

System bus 506 is also coupled to a hard drive interface 532, which interfaces with a hard drive 534. In a preferred embodiment, hard drive 534 populates a system memory 536, which is also coupled to system bus 506. Data that populates system memory 536 includes service provider server 502's operating system 538, which includes a shell 540 and a kernel 542. Shell 540 is incorporated in a higher level operating system layer and utilized for providing transparent user access to resources such as application programs 544, which include a browser 546, and a copy of OCC 448 described above, which can be deployed to client computer 402.

The hardware elements depicted in service provider server 502 are not intended to be exhaustive, but rather are representative to highlight essential components required by the present invention. For instance, service provider server 502 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 502 performs all of the functions associated with the present invention (including execution of OCC 448), thus freeing client computer 402 from using its resources.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

As described above, in one embodiment, the processes described by the present invention, including the functions of OCC 448, are performed by service provider server 502. Alternatively, OCC 448 and the method described herein, and in particular as shown and described in FIGS. 1-3, can be deployed as a process software from service provider server 502 to client computer 402. Still more particularly, process software for the method so described may be deployed to service provider server 502 by another service provider server (not shown).

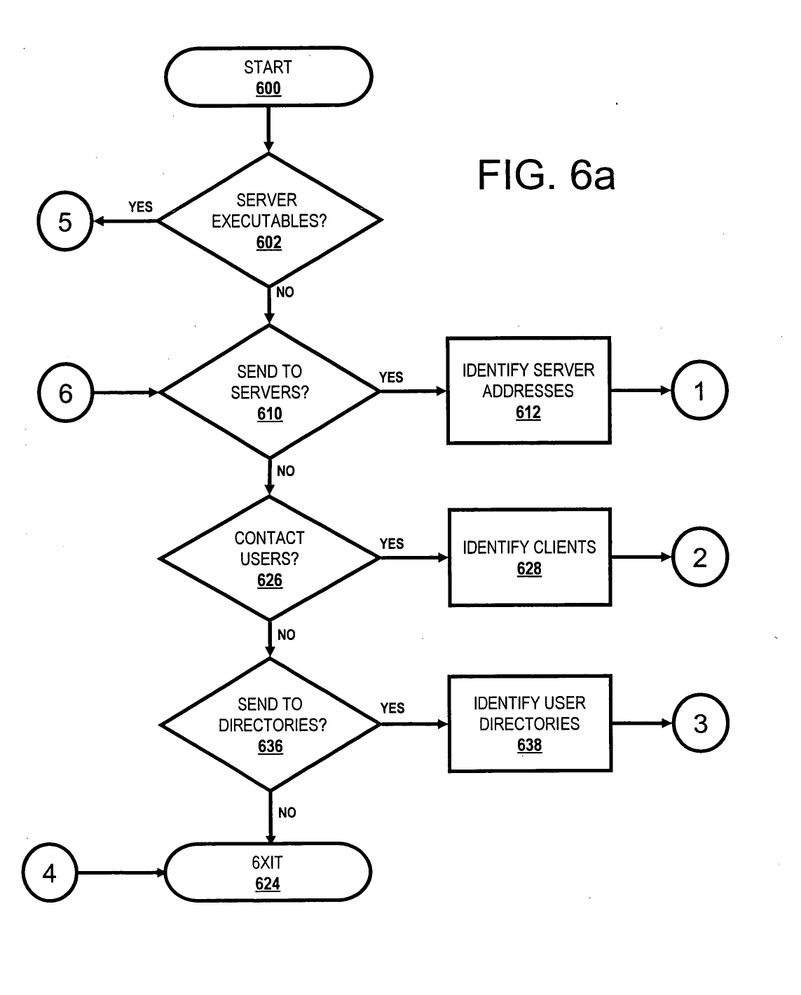

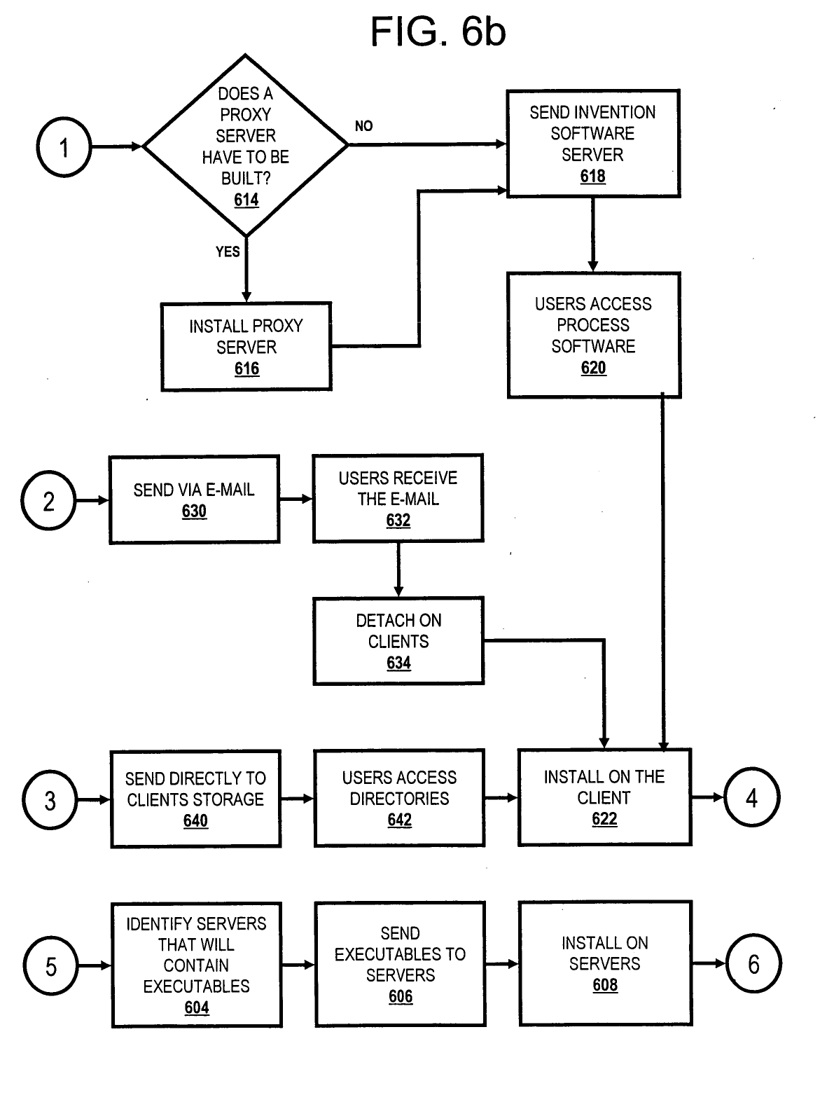

Referring then to FIG. 6, step 600 begins the deployment of the process software. The first thing is to determine if there are any programs that will reside on a server or servers when the process software is executed (query block 602). If this is the case, then the servers that will contain the executables are identified (block 604). The process software for the server or servers is transferred directly to the servers' storage via File Transfer Protocol (FTP) or some other protocol or by copying though the use of a shared file system (block 606). The process software is then installed on the servers (block 608).

Next, a determination is made on whether the process software is to be deployed by having users access the process software on a server or servers (query block 610). If the users are to access the process software on servers, then the server addresses that will store the process software are identified (block 612).

A determination is made if a proxy server is to be built (query block 614) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 616). The process software is sent to the servers either via a protocol such as FTP or it is copied directly from the source files to the server files via file sharing (block 618). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 620). Another embodiment is to have the servers automatically copy the process software to each client and then run the installation program for the process software at each client computer. The user executes the program that installs the process software on his client computer (block 622) then exits the process (terminator block 624).

In query step 626, a determination is made whether the process software is to be deployed by sending the process software to users via e-mail. The set of users where the process software will be deployed are identified together with the addresses of the user client computers (block 628). The process software is sent via e-mail to each of the users' client computers (block 630). The users then receive the e-mail (block 632) and then detach the process software from the e-mail to a directory on their client computers (block 634). The user executes the program that installs the process software on his client computer (block 622) then exits the process (terminator block 624).

Lastly a determination is made on whether to the process software will be sent directly to user directories on their client computers (query block 636). If so, the user directories are identified (block 638). The process software is transferred directly to the user's client computer directory (block 640). This can be done in several ways such as, but not limited to, sharing of the file system directories and then copying from the sender's file system to the recipient user's file system or alternatively using a transfer protocol such as File Transfer Protocol (FTP). The users access the directories on their client file systems in preparation for installing the process software (block 642). The user executes the program that installs the process software on his client computer (block 622) and then exits the process (terminator block 624).

VPN Deployment

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process the of placing an entire packet within another packet and sending it over a network. The protocol of the outer packet is understood by the network and both points, called runnel interfaces, where the packet enters and exits the network.

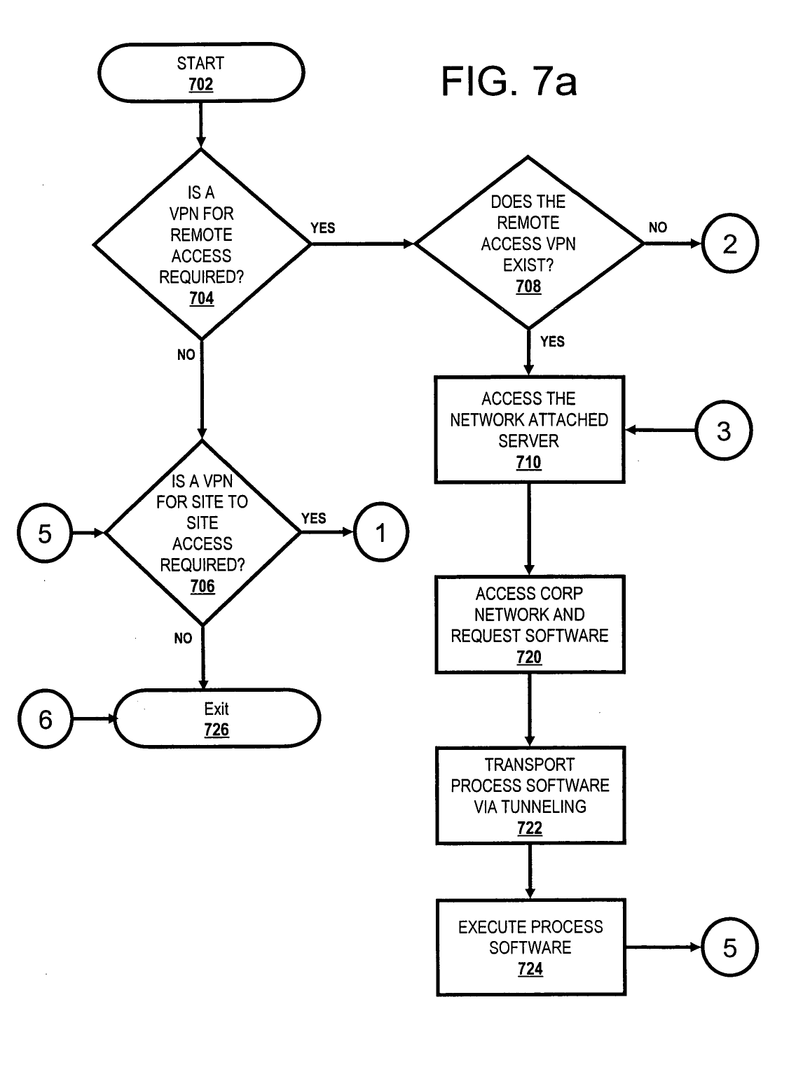

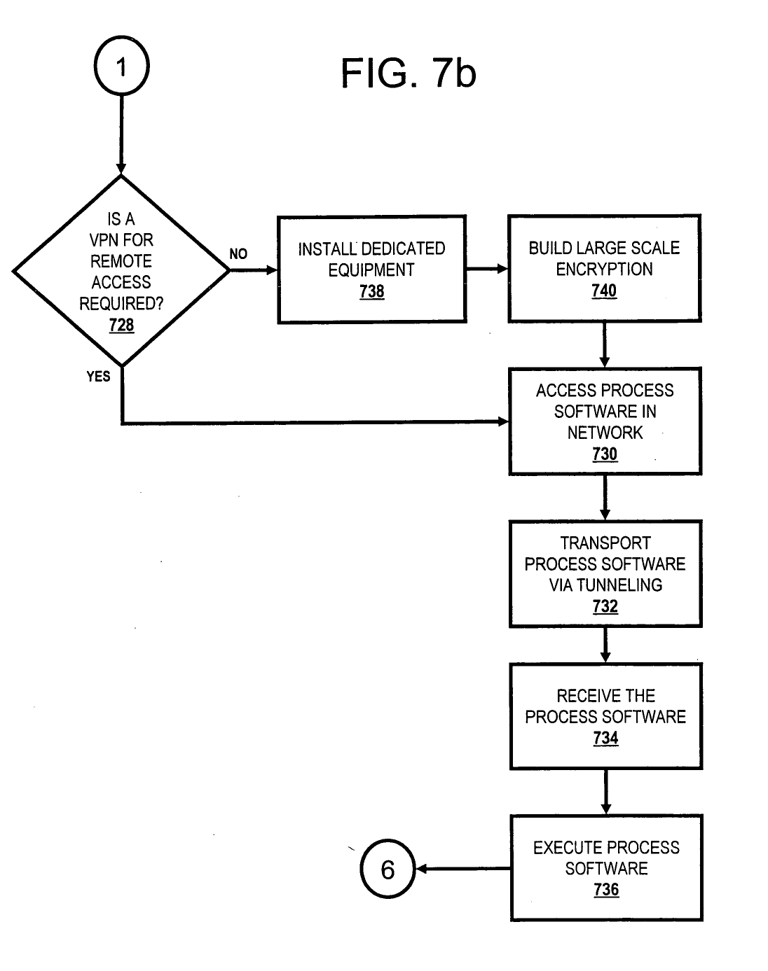

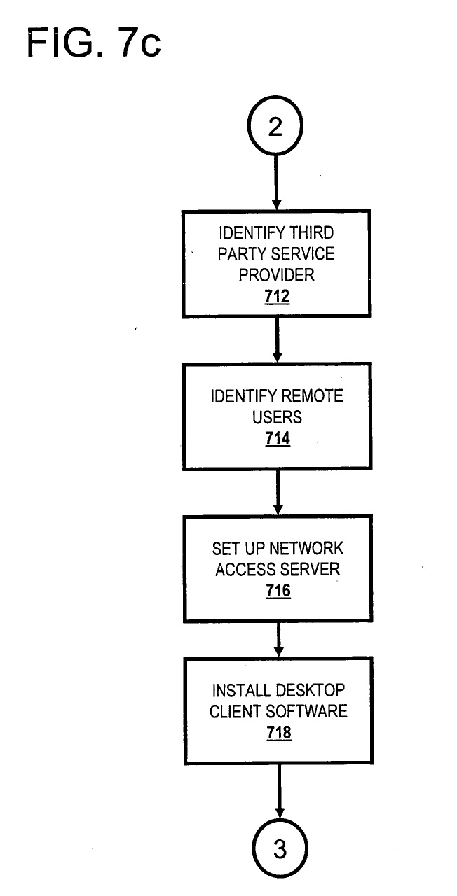

The process for such VPN deployment is described in FIG. 7. Initiator block 702 begins the Virtual Private Network (VPN) process. A determination is made to see if a VPN for remote access is required (query block 704). If it is not required, then proceed to (query block 706). If it is required, then determine if the remote access VPN exists (query block 708).

If a VPN does exist, then proceed to block 710. Otherwise identify a third party provider that will provide the secure, encrypted connections between the company's private network and the company's remote users (block 712). The company's remote users are identified (block 714). The third party provider then sets up a network access server (NAS) (block 716) that allows the remote users to dial a toll free number or attach directly via a broadband modem to access, download and install the desktop client software for the remote-access VPN (block 718).

After the remote access VPN has been built or if it has been previously installed, the remote users can access the process software by dialing into the NAS or attaching directly via a cable or DSL modem into the NAS (block 710). This allows entry into the corporate network where the process software is accessed (block 720). The process software is transported to the remote user's desktop over the network via tunneling. That is, the process software is divided into packets and each packet including the data and protocol is placed within another packet (block 722). When the process software arrives at the remote user's desktop, it is removed from the packets, reconstituted and then is executed on the remote user's desktop (block 724).

A determination is then made to see if a VPN for site to site access is required (query block 706). If it is not required, then proceed to exit the process (terminator block 726). Otherwise, determine if the site to site VPN exists (query block 728). If it does exist, then proceed to block 730. Otherwise, install the dedicated equipment required to establish a site to site VPN (block 738). Then build the large scale encryption into the VPN (block 740).

After the site to site VPN has been built or if it had been previously established, the users access the process software via the VPN (block 730). The process software is transported to the site users over the network via tunneling (block 732). That is the process software is divided into packets and each packet including the data and protocol is placed within another packet (block 734). When the process software arrives at the remote user's desktop, it is removed from the packets, reconstituted and is executed on the site user's desktop (block 736). The process then ends at terminator block 726.

Software Integration

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

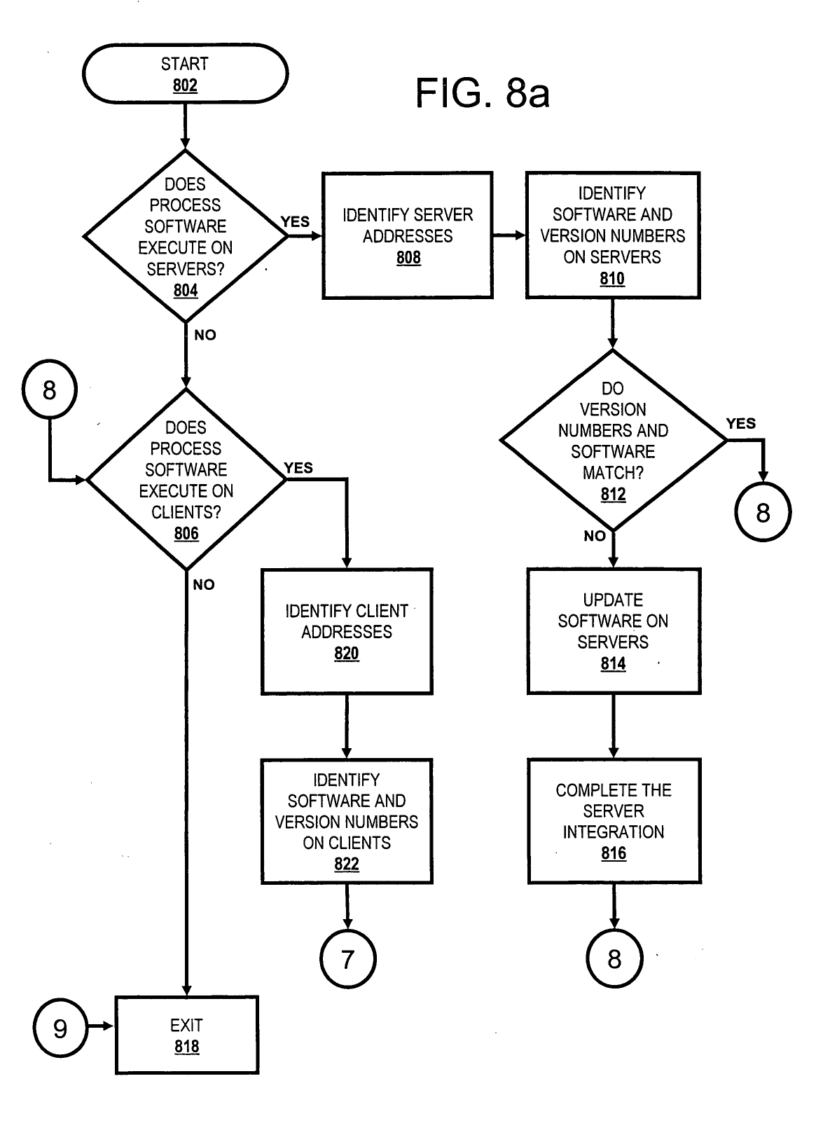

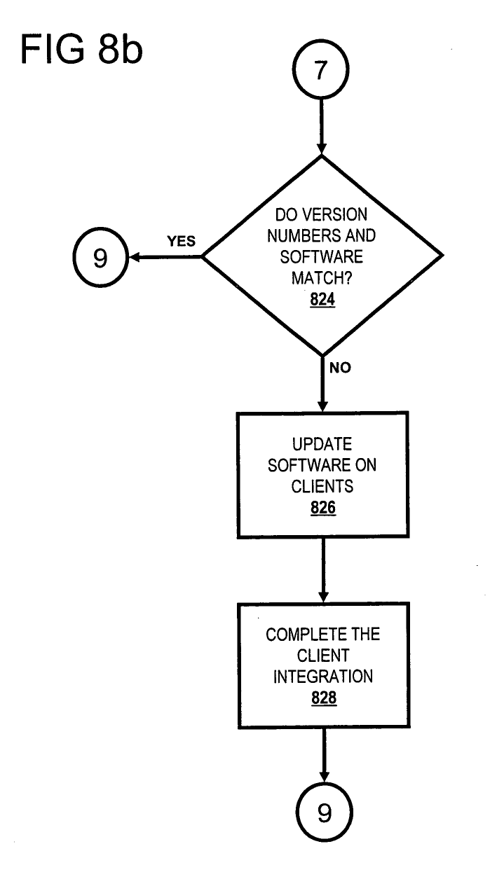

For a high-level description of this process, reference is now made to FIG. 8. Initiator block 802 begins the integration of the process software. The first tiling is to determine if there are any process software programs that will execute on a server or servers (block 804). If this is not the case, then integration proceeds to query block 806. If this is the case, then the server addresses are identified (block 808). The servers are checked to see if they contain software that includes the operating system (OS), applications, and network operating systems (NOS), together with their version numbers, which have been tested with the process software (block 810). The servers are also checked to determine if there is any missing software that is required by the process software in block 810.

A determination is made if the version numbers match the version numbers of OS, applications and NOS that have been tested with the process software (block 812). If all of the versions match and there is no missing required software the integration continues in query block 806.

If one or more of the version numbers do not match, then the unmatched versions are updated on the server or servers with the correct versions (block 814). Additionally, if there is missing required software, then it is updated on the server or servers in the step shown in block 814. The server integration is completed by installing the process software (block 816).

The step shown in query block 806, which follows either the steps shown in block 804, 812 or 816 determines if there are any programs of the process software that will execute on the clients. If no process software programs execute on the clients the integration proceeds to terminator block 818 and exits. If this not the case, then the client addresses are identified as shown in block 820.

The clients are checked to see if they contain software that includes the operating system (OS), applications, and network operating systems (NOS), together with their version numbers, which have been tested with the process software (block 822). The clients are also checked to determine if there is any missing software that is required by the process software in the step described by block 822.

A determination is made is the version numbers match the version numbers of OS, applications and NOS that have been tested with the process software (query block 824). If all of the versions match and there is no missing required software, then the integration proceeds to terminator block 818 and exits.

If one or more of the version numbers do not match, then the unmatched versions are updated on the clients with the correct versions (block 826). In addition, if there is missing required software then it is updated on the clients (also block 826). The client integration is completed by installing the process software on the clients (block 828). The integration proceeds to terminator block 818 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

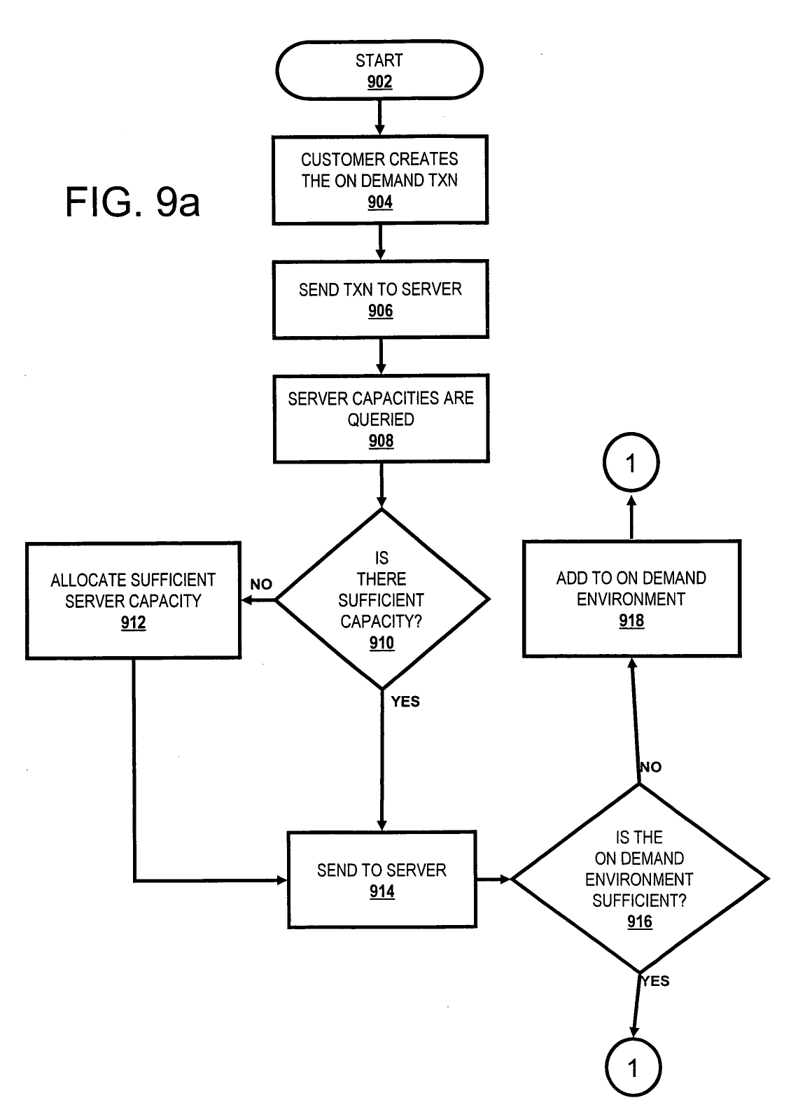

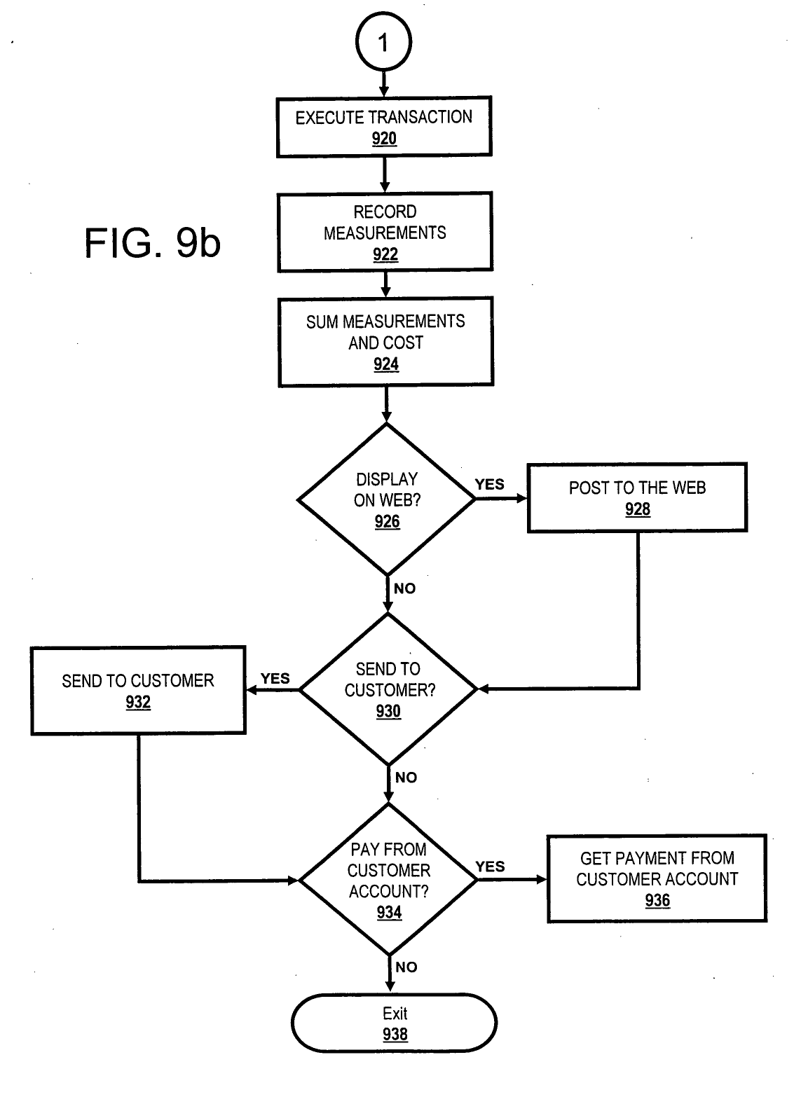

With reference now to FIG. 9, initiator block 902 begins the On Demand process. A transaction is created than contains the unique customer identification, the requested service type and any service parameters that further, specify the type of service (block 904). The transaction is then sent to the main server (block 906). In an On Demand environment the main server can initially be the only server, then as capacity is consumed other servers are added to the On Demand environment.

The server central processing unit (CPU) capacities in the On Demand environment are queried (block 908). The CPU requirement of the transaction is estimated, then the servers available CPU capacity in the On Demand environment are compared to the transaction CPU requirement to see if there is sufficient CPU available capacity in any server to process the transaction (query block 910). If there is not sufficient server CPU available capacity, then additional server CPU capacity is allocated to process the transaction (block 912). If there was already sufficient Available CPU capacity then the transaction is sent to a selected server (block 914).

Before executing the transaction, a check is made of the remaining On Demand environment to determine if the environment has sufficient available capacity for processing the transaction. This environment capacity consists of such things as but not limited to network bandwidth, processor memory, storage etc. (block 916). If there is not sufficient available capacity, then capacity will be added to the On Demand environment (block 918). Next the required software to process the transaction is accessed, loaded into memory, then the transaction is executed (block 920).

The usage measurements are recorded (block 922). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 924).

If the customer has requested that the On Demand costs be posted to a web site (query block 926), then they are posted (block 928). If the customer has requested that the On Demand costs be sent via e-mail to a customer address (query block 930), then these costs are sent to the customer (block 932). If the customer has requested that the On Demand costs be paid directly from a customer account (query block 934), then payment is received directly from the customer account (block 936). The On Demand process is then exited at terminator block 938.

The present method and system thus provides a way to consolidate documents for a product that is out-of-support into a single archive package that is accessible from a single webpage. The single archive package includes static and unchanging updates, fixes, redbooks, Authorized Problem Analysis Reports (APARs) and Document Control Facility (DCF) published content related to the out-of-support product. To access and use the archive package, the provider of the product and/or its support then provides access to users, either by storing the archive package on a server, or by downloading to the user's computer the archive package (either in zipped or unzipped format). Because the product is out-of-support, no new documents/downloads/plug-ins etc. will be developed by the producer in the future for the out-of-support product. Thus, the archive package can be considered a static, unchanging artifact. By having the archive package in a separate location, all data for out-of-support releases can easily be located and used on-line or downloaded for local access. By being directly accessed by the user at the user's computer, the user can be assured of having the last product support published for the now out-of-support product. Furthermore, by removing out-of-support content from a current (supported) product webpage, clutter is reduced on the current product webpage.

To let users of the out-of-support product know that they can access the single archive package, a flash message is published, on the webpage for the newer in-support version of the out-or-support product, announcing the availability of the archive package. Note that content in the archive package includes both content locatable by a web crawler as well as content that is not locatable by a web crawler.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method comprising:
consolidating support documents for a product that is out-of-support into an archive package that is accessible from a single webpage.

2. The computer-implementable method of claim 1, wherein the archive package includes static and unchanging updates, fixes, redbooks, Authorized Problem Analysis Reports (APARs) and Document Control Facility (DCF) published content related to the out-of-support product.

3. The computer-implementable method of claim 1, further comprising:
downloading the archive package to a user's computer, wherein the archive package is a single static file that is accessible directly from the user's computer.

4. The computer-implementable method of claim 3, further comprising:
zipping the archive package into a Zip file before downloading the archive package to the user's computer.

5. The computer-implementable method of claim 1, further comprising:
on a webpage for a newer in-support version of the out-or-support product, publishing a flash message announcing the availability of the archive package.

6. The computer-implementable method of claim 1, wherein content found in the archive package includes both content locatable by a web crawler as well as content that is not locatable by a web crawler.

7. A system comprising:
a processor;
a data bus coupled to the processor; and
a computer-usable medium embodying computer program code, the computer-usable medium being coupled to the data bus, the computer program code comprising instructions executable by the processor and configured for:
consolidating support documents for a product that is out-of-support into an archive package that is accessible from a single webpage.

8. The system of claim 7, wherein the archive package includes static and unchanging updates, fixes, redbooks, Authorized Problem Analysis Reports (APARs) and Document Control Facility (DCF) published content related to the out-of-support product.

9. The system of claim 7, wherein the instructions are further configured for:
downloading the archive package to a user's computer, wherein the archive package is a single static file that is accessible directly from the user's computer.

10. The system of claim 9, wherein the instructions are further configured for:
zipping the archive package into a Zip file before downloading the archive package to the user's computer.

11. The system of claim 7, wherein the instructions are further configured for:
on a webpage for a newer in-support version of the out-or-support product, publishing a flash message announcing the availability of the archive package.

12. The system of claim 7, wherein content found in the archive package includes both content locatable by a web crawler as well as content that is not locatable by a web crawler.

13. A computer-usable medium embodying computer program code, the computer program code comprising computer executable instructions configured for:
consolidating support documents for a product that is out-of-support into an archive package that is accessible from a single webpage.

14. The computer-usable medium of claim 13, wherein the archive package includes static and unchanging updates, fixes, redbooks, Authorized Problem Analysis Reports (APARs) and Document Control Facility (DCF) published content related to the out-of-support product.

15. The computer-usable medium of claim 13, wherein the embodied computer program code further comprises computer executable instructions configured for:
downloading the archive package to a user's computer, wherein the archive package is a single static file that is accessible directly from the user's computer.

16. The computer-usable medium of claim 15, wherein the embodied computer program code further comprises computer executable instructions configured for:
zipping the archive package into a Zip file before downloading the archive package to the user's computer.

17. The computer-usable medium of claim 13, wherein the embodied computer program code further comprises computer executable instructions configured for:
on a webpage for a newer in-support version of the out-or-support product, publishing a flash message announcing the availability of the archive package.

18. The computer-usable medium of claim 13, wherein content found in the archive package includes both content locatable by a web crawler as well as content that is not locatable by a web crawler.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
